(19) United States
(12) Patent Application Publication
(10) Pub. No.: US 2003/0219196 A1
(43) Pub. Date: Nov. 27, 2003

(54) Microarray system and method of use thereof

(76) Inventors: Tsu-Chien Weng, Ann Arbor, MI (US); Tsu-Tseng Weng, Taipei (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 10/063,890

(22) Filed: May 22, 2002

(51) Int. Cl. G02B 6/35; G02B 6/26

(52) U.S. Cl. 385/17; 385/15

(57) ABSTRACT

The present invention integrates an optical switch, a microlens array and a triple-unit light-directed combinatorial synthesis. By applying optical switching technology and waveguides, the present invention can actively control and carry out light-directed solid-state combinatorial synthesis without implementation of photomasks. The system and the related methodologies of this invention further incorporate individually independent detection for each spot of the microarray system without background interference. Microlens arrays coupled with the optical waveguide switch can be implemented in the CCD-LED detection system or laser scanning system for microarray detection in the present invention.

### BACKGROUND OF INVENTION

1. Field of Invention

The present invention relates to the design and uses of a microarray system. More particularly, the present invention relates to the design and uses of a microarray system, which can actively control and carry out solid-state combinatorial synthesis without implementation of photomasks.

2. Description of Related Art

High-density microarray technologies can allow researchers access to valuable genetic information and provide efficient synthesis. The key to oligonucleotide microarray synthesis is the ability to provide light patterns for directing the oligonucleotide synthesis on the microarray. Various mechanisms have been proposed to incorporate effective light patterns into the microarray technology. Because of the advancements in semiconductor technologies, the use of photolithography was first applied for light patterns in the synthesis of the microarrays. This technique worked well for patterning light, but was expensive and cumbersome as a result of the large number of expensive photolithographic masks. Alternatively, a computer-controlled micromirror array technology was developed to replace the photolithographic masks with “virtual masks”. The micromirror array technology involves the use of thousands of micromirror to project tiny light patterns onto different location, thus photo-activating synthesis at different locations. However, reflection through various mirrors and lens greatly increase power loss and flatness of the micromirrors limits the effectiveness. Besides, micromirror array technology is prone to error scattering in three-dimensionally controlling mechanism.

### SUMMARY OF INVENTION

The present invention relates to the design, fabrication, and uses of a microarray system, which integrates an optical switch, a microlens array and a triple-unit light-directed combinatorial synthesis. By applying optical switching technology and waveguides, the present invention can actively control and carry out solid-state combinatorial synthesis without implementation of photomasks.

The optical waveguide switch of the present invention can control light emitted from the light source to precisely aim at any specific location (spot) on the microarray without using photomasks. Optical waveguide switching technology endows a more precise light transmission pointing toward a specific spot, thus inducing a site-specific photoreaction. In addition, the usage of optical waveguide ensures total reflection of light and minimizes intensity loss.

The present invention uses three nucleotide bases as one synthesizing unit (triple-unit), instead of single nucleotide, for solid-state combinatorial synthesis. By using the triple-unit for oligonucleotide sequence synthesis, the present invention can achieve efficient synthesis and result in high yields. The triple-unit combinatorial library of the present invention is biologically more meaningful and helpful in increasing accuracy. Moreover, this combinatorial strategy can shorten manufacturing time and significantly reduce production cost.

The system and the related methodologies of this invention further incorporate individually independent detection for each spot of the microarray system without background interference. Microlens arrays coupled with the optical waveguide switch can be implemented in the CCD-LED detection system or laser scanning system for microarray detection in the present invention.

It is to be understood that both the foregoing general description and the following detailed description are exemplary, and are intended to provide further explanation of the invention as claimed.

### BRIEF DESCRIPTION OF DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 is a display view of the structure of an optical waveguide switch according to one preferred embodiment of the present invention;

FIGS. 2a-2b are schematic views showing the principles of light transmission and light reflection, respectively for the optical switch according to one preferred embodiment of this invention, while the left sides of FIGS. 2a-2b are top views of a portion of the optical waveguide switch and the right sides of FIGS. 2a-2b are cross-sectional views of a portion of the optical waveguide switch;

FIGS. 3a-3e illustrates the principle of light-directed synthesis with the photolithographic technology; and

FIGS. 4a-4d illustrates the principle light-directed synthesis according to one preferred embodiment of the present invention.

### DETAILED DESCRIPTION

The present invention relates to the design, fabrication, and uses of a microarray system, which can actively control and carry out solid-state combinatorial synthesis without implementation of photomasks. By applying optical switching technology and waveguides in light-directed solid-phase combinatorial synthesis, precise in-situ synthesis of desirable probes with different functional groups or structures is endowed.

Moreover, three nucleotide bases are used as one synthesizing unit (triple-unit), instead of single nucleotide, for solid-state combinatorial synthesis.

The system and the related methodologies of this invention further incorporate individually independent detection for each spot of the microarray system without background interference.

Optical Waveguide Switch

The optical cross-connect switch is suitable for flexible and reliable photonic transmission and for reconfigurable optical inter-module connection in large-scale processing system. The optical switches can be divided into two main categories as optomechanical switches and solid-state waveguide switches. The optomechanical switches can adopt various mechanisms, including bending fiber, sliding prism and tilting mirror etc. The solid-state waveguide switches include electro-optic switches, thermo-optic switches, acoust-optic switches and non-linear optic switches. Incorporating micro-electro-mechanical systems (MEMS) in optical switches can help decrease sizes and reduce costs. Various types of optical cross-connect switches can be adopted by the present invention, while the following paragraphs merely disclose an exemplary mechanism suitable for the optical waveguide switch of the present invention.

Makihara et al. proposed a micromachinery-controlled optical waveguide switch by using an intersecting waveguide matrix. A small n x n optical switch that includes at least an intersecting waveguide matrix, matching oil, and microactuators has advantages in terms of small size and low loss, and its low dependence on polarization and wavelength. Such switching is based on the movement of oil due to capillary pressure, which is controlled by the microactuator. The optical switch has stable switching by using the microactuator. The optical switch is of low loss, because total reflection is obtained from using the waveguide matrix and the matching oil.

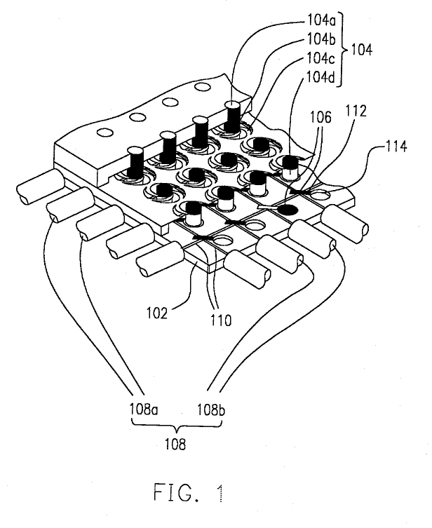

The structure of the optical switch 100 having at least a waveguide matrix 102, microactuators 104, matching oil 106, and optical fibers 108, is shown in FIG. 1. Optical fibers 108 are arranged aside the waveguide matrix 102 as input optical fibers 108a and output optical fibers 108b for transmitting light. In the waveguide matrix 102, rows and columns of waveguide cores 110 intersect. At each intersection, there is a groove 112 connected to an oil pool 114. Matching oil 106 is in the grooves 112 and oil pools 114. Matching oil 106 and the waveguide core 110 have the same refractive indexes. One microactuator 104 is arranged above each intersection of the waveguide matrix 102. The microactuator 104 is an electromagnetic actuator consisting of an electromagnet 104a, a permanent magnet 104b, a spring 104c, and a cylinder 104d. The permanent magnet 104b and the cylinder 104d are mounted on the spring 104c.

Actuation is based on the balance of two forces: the elastic force of the spring 104c and the magnetic force between the electromagnet 104a and the permanent magnet 104b. That is, the actuator raises or lowers the cylinder out of or into the oil pool according to the current applied to the electromagnet. As a result, light is either transmitted through or reflected at the intersection. Therefore, any optical path between the input optical fibers and the corresponding output optical fibers can be determined by controlling the currents to the electromagnets.

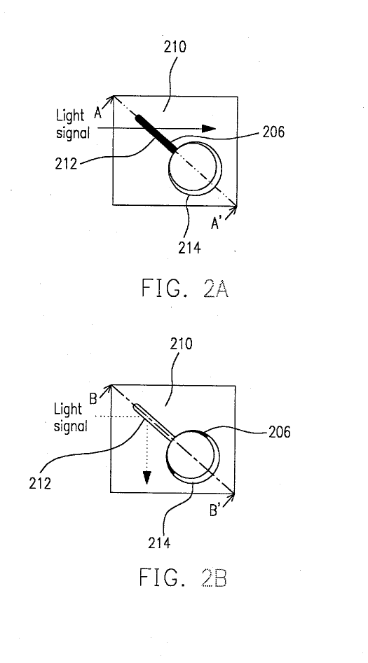

Each intersection is a basic element of this optical switch. The switching principle is demonstrated by the following schematics shown in FIGS. 2a-2b. When the groove 212 is filled with matcing oil 206, light is transmitted straight through the groove 212 into the waveguide core 210. On the contrary, when the groove 212 is empty, light is totally reflected at the interface between the core and the air and is deflected into the intersecting waveguide core. Thus, the switching is based on the movement of oil between the groove 212 and the oil pool 214.

Several critical conditions are required for switching the direction of light. To transmit the light through the groove, there must be enough oil to cover the waveguide core in the groove. On the other hand, to reflect the light at the interface between the core and air, following conditions must be satisfied: (1) when the cylinder is lowered into the oil pool, the cylinder must touch the oil in order to produce the capillary pressure; (2) when the cylinder is lowered, the gap between the cylinder and the bottom and sidewalls of the oil pool must be narrower than the groove width so that the capillary pressure at the oil-air interface in the gap is larger than that in the groove; and (3) when the cylinder is lowered, the volume of the gap must be greater than that of the oil, because the oil in the groove must move into the gap. The gap volume is the volume where the gap between the cylinder and the bottom and the sidewalls of the pool is narrower than the groove width. Therefore, the oil volume is important for light transmission and the cylinder position is important for light reflection.

The movement of oil is decided by capillary pressure at the oil-air interface. Therefore, when the gap between the cylinder and the bottom and sidewalls of the pool is made narrower than the groove width by lowering the cylinder into the pool, the capillary pressure at the oil-air interface in the gap draws the oil out of the groove. Conversely, when the gap is made wider than the groove width by raising the cylinder, the capillary pressure in the groove draws the oil into the groove. In this way, the microactuator can control matching oil out of or into the groove, hence regulating the light direction.

By using the optical waveguide switch, light emitted from the light source can be precisely controlled to aim at any specific location (spot) on the microarray without using photomasks. The light aiming at each spot can be controlled independently by a computer system connected to the optical switch. Furthermore, the intensity of light aiming at the specific location can be adjusted according to the required energy for the synthesis species.

Light-Directed Solid-Phase Combinatorial Synthesis

Solid-phase peptide synthesis is an iterative process, in which a suitable solid support is first acylated with an N-protected amino acid, the protecting group is removed, and then the process is repeated with the next amino acid until the desired peptide is assembled. Based on this technique, Fodor and colleagues developed a chemistry-driven technology that combines the tools of solid-phase peptide chemistry, photolabile protecting groups, and photolithography to construct extremely compact arrays of compounds on glass substrates, or chips.

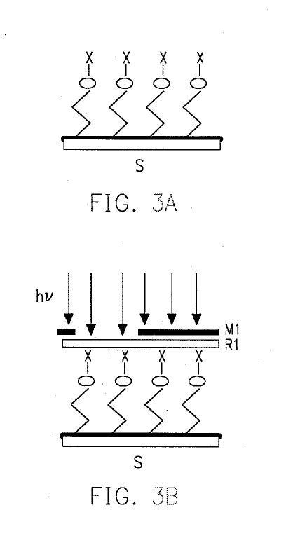

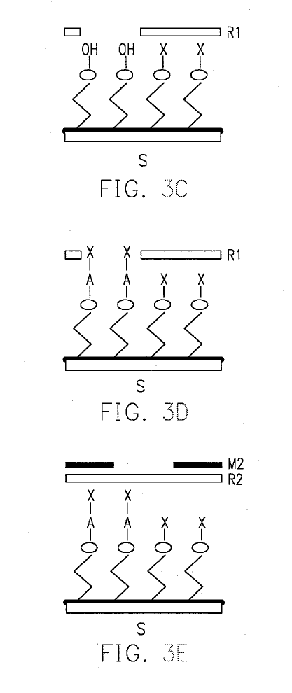

Conventional light-directed synthesis requires repetitive applications of photolithographic masks, as shown in FIGS. 3a-3e. The substrate S is modified with photolabile protecting groups X. Through a lithographic mask M1, photoresist R1 is patterned and the substrate is selectively exposed to light and the exposed regions are deprotected. Afterwards, the substrate is treated with an activated amino acid A, and acylation occurs only in those regions that are photodeprotected. After washed and coating photoresist R2, a second mask M2 is applied and the process is repeated. However, the costs of photolithographic masks are high and applications of photoresists cause undesired problems.

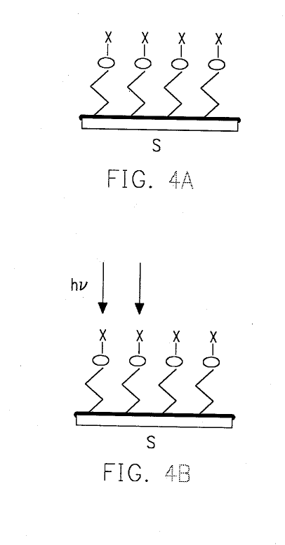

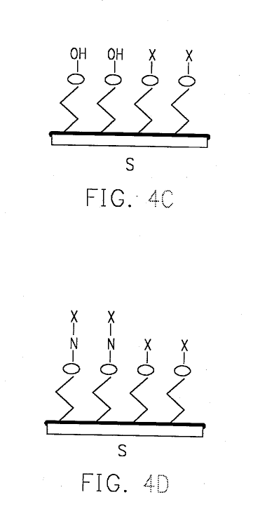

In the present invention, no expensive photolithographic masks and repetitive photoresists are required by using optical switches for controlling light onto specific locations. As shown in FIGS. 4a-4d, the lightwave controlled by the optical switch (not shown) can photodeprotect the photolabile protecting groups modified over the substrate individually and independently. During the process of light-directed oligonucleotide synthesis on a solid support, photolabile 5″-protecting groups X are selectively removed from growing oligonucleotide chains in predefined regions of a functionalized non-porous solid support (substrate, S) by precisely waveguide-controlled UV or near-UV light. After selectively photodeprotecting the oligonucleotide chains on the substrate, activated nucleotides N are added and reacted with the deprotected oligonucleotide chains in predetermined regions.

The materials for the substrate include, but are not limited to, glass, plastic, polyester (PET), polyimide (PI), polystyrene (PS) or silicon material, depending on various considerations for the design and fabrication of system. Prior to photosynthesis, the substrate needs to be treated to become a functionalized substrate. That is, chemical methods are used to activate the surface of the substrate with an immobilized synthesizing unit. Preferably, the synthesizing unit includes three linked nucleotides. This immobilized synthesizing unit will be used as a starting point for further synthesis of the probe on the location of the substrate. Covalent disulfide bonds have been used to immobilized oligonucleotides through thiol or disulfide containing nucleic acid molecules and a mercaptosilane coated solid surface. Alternatively, the nucleotides can be immobilized to a solid surface by means of a covalent ether or thioether linkage. Conventional light-directed synthesis reagents and protocols can be implemented in the present invention, and the reaction conditions are adjusted based on the synthesis species and the substrate.

In the present invention, light-directed synthesis in combination of the optical switching technology result in high density synthesis in a compact area, possibly thousands of features on the substrate. This miniaturization serves to reduce reagent consumption, particularly when performing post-synthesis bioassays. The entire array of immobilized compounds (features) can be assayed by a single incubation of the molecular binding agent of interest, such as antibody, enzyme, receptor or nucleic acids, typically requiring less than 1 ml of the recoverable assay solution.

Optical waveguide switching technology endows a more precise light transmission pointing toward a specific spot, thus inducing a site-specific photoreaction. In addition, the usage of optical waveguide ensures total reflection of light and minimizes intensity loss. In comparison with multiple reflections applied in micromirror array technology, the optical waveguide switch has a simpler and straightforward light path, thus minimizing loss of intensities. The optical switch of the present invention, such as, the aforementioned optical waveguide switch, is superior in the uni-dimensionally switching mechanism to reduce mechanical mistakes and increase precision. Moreover, the optical switch assures directing light in a well-defined path without limitations of mirror flatness.

Three Nucleotide Basas Deposition

Using optical waveguide switching technology in light-directed solid-phase combinatorial synthesis, especially in growing oligonucleotide chains on a solid support, would gain advantages in large capacities of combinatorial library. In depositing deoxyribonucleotides, traditional approach is to construct a simple combinatorial library of four different nucleotide bases, namely A, G, C, and T. A 4×4 matrix of those nucleotide bases is thus constructed and 16 variations of photolithographic masks are used for generating the pattern.

In the present invention, three linked nucleotide bases are used as one synthesizing unit (triple-unit), instead of single nucleotide, for solid-state combinatorial synthesis. The present invention adopts a more efficient approach that combines optical switching technology and triple-unit combinatorial libraries, thus avoiding tedious procedures. In this novel approach, a triple-unit combinatorial library is constructed on the basis of variations of all triple nucleotides, namely AAA, AAG, ACT, GCA . . . etc. This library is composed of 4³, namely 64 triple nucleotides. This combinatorial library can then be controlled and managed by a 64×64 switching mechanism, preferably the aforementioned optical waveguide switch.

The triple unit (three nucleotide bases) used in the present invention can correspond to genetic codes, codons or anti-codons, thus avoiding random errors or single base error during the synthesis process. By using the triple-unit for oligonucleotide sequence synthesis, the present invention can achieve efficient synthesis and result in high yields. The triple-unit combinatorial library of the present invention is biologically more meaningful and helpful in increasing accuracy. Moreover, this combinatorial strategy can shorten manufacturing time and significantly reduce production cost.

An interconnected feeding unit is used to separately store those triple nucleotides (three linked oligonucleotides) in different subdivisions. The interconnected feedcell can be controlled by a programmed computer system to supply the specific triple oligonucleotides individually to the desired sites (spot) on the substrate from step to step. A photoacid precursor supply is implemented to provide photoacid. Alternatively, the photoacid precursor can be pre-mixed with various triple oligonucleotides. The photoacid precursor is mixed with such triple oligonucleotides at a concentration of about 0.5 mM to assure deprotection and covalent binding. The photoacid precursor will be excited by waveguide-directed UV light to release proton for deprotecting the upper-capped protected groups at the deposited and growing site.

Furthermore, a feedback control unit can be further included for controlling the feed-in of the triple nucleotides and the energy incoming light wave. Different triple nucleotides may require different energy to photoactivate the linking reaction. The feedback control unit integrates the requirements for feeding the raw material (triple nucleotides) and the energy necessary for photoactivating it. In this way, the intensity of light aiming at the specific spot can be adjusted based on the required energy for the synthesis species.

The synthesized oligonucleotides can be used as probes for further genetic screening. The synthesis method disclosed in the present invention is not only limited to the oligonucleotide synthesis, but also can be applied to synthesize small peptides, polypeptides or even oligosaccharides, by adjusting reaction conditions based on further experimentation.

Detection

After hybridizing with marked targets, a detection method is required to detect the hybridized complexes with label marks on spots. One common detection method is to use a fluorescent imaging detector system in combination with a fluorescence confocal microscope. In order to eliminate the background signals, the spots in the microarray are scanned one by one. For the scanning process of each spot, the laser excitation, using as the light source, is focused by the objective lens to excite the fluorescence labels in the spot and the emitted fluorescence from each spot is focused and then detected. However, it is very time-consuming to scan the microarray spot by spot and the focused laser can cause photo-damage sometimes. Therefore, the present invention proposed an alternative mechanism to implement detection with high sensitivity and low background.

Microlens arrays coupled with the optical waveguide switch can be implemented in the CCD-LED detection system or laser scanning system for microarray detection in the present invention. Thousands of microlens arrayed on a substrate can be used for aligning and focusing incident light directed through 4×4, 8×8, 16×16, 32×32, or 64×64 optical switch waveguides in the scanner system (detection system). Therefore, the traditional scanner setup is multiplied into an integrated arrayed scanner system.

The technique for fabricating the microlens array is described in brief. At first, an adhesive hydrophobic layer is mechanically applied to the substrate. If adhesion, rather than covalent bonding, is used to apply the hydrophobic layer, the same hydrophobic material can be used with a variety of substrate material systems. As an example of this flexibility, we have used an adhesive coating of RainX on Si, SiO2, and SiN, and an adhesive coating of “Turtle Wax Super Hard Shell Car Wax” on GaAs, InP, GaInAs, and other ll-V materials, to make these materials hydrophobic. The substrate can then be lithographically patterned and the hydrophobic layer selectively etched away from the exposed regions. The substrate is then dipped into and withdrawn from an UV-curable-monomer solution. The monomer can self-assemble into lenses on the hydrophilic domains. After an UV-cure the lenses become hard and stable. This fabricating technique can easily be modified to achieve double-sided convex lenses.

The optical switches are implemented with a robotically controlled x-y moving arm to direct incident light emitted from the above of the optical switches. The optical switch can allow different light waves emitted from vertically position direct through the waveguides by the electronic switching mechanism. If laser is used, the laser light sources can then be modulated into different wavelengths and switched for scanning. Light is conducted through the optical switch waveguides and focused by specific lens on the microlens arrays. The detection system further includes a 45° aligned splitter, which will transmit the incoming light to the scanned microarrays and reflect the emitted fluorescence to the waveguides. The receiver-side optical switch is also controlled by a x-z moving robotic arm. Because of the integrated arrays of lenses and waveguides, light signal transmitted from specific sites to sites in a more precise way, just like the barcode scanning.

Compared with conventional laser excitation used for fluorescence microscopy, the light source for detection of the present invention is replaced by multiple in-parallel incoming light though waveguides. The present invention uses microlens arrays to focus light onto each specific spot on the microarray substrate. Multiple in-parallel fluorescence emitted from the spots are then transmitted through splitter and reflector mirrors, emission filter, and the other aligned microlens arrays to the receiver waveguides, then conducting to the detector. The spots of the present invention are detected (scanned) individually and parallel to one another, rather than spot by spot. By this way, the tedious scanning scheme of the fluorescence confocal microscopy is avoided. On the other hand, waveguides coupled with microlens arrays are implemented to precisely control light transmission and fluorescence emission paths, so as to enhance detection intensities overall.

The light source of the present invention can be either CCD-LED type or laser emission-transmission type. CCD-LED setup is more preferred for the scanner (detection) system of the present invention. CCD-LED setup includes at least a Charge coupled device (CCD), some electronic circuitry and a light emission diode (LED) above the light sensing face of the CCD as a light source. The CCD serves as a photon-sensing, storage and information-transferring element. For example, the CCD can represent a single row of photocells on a semiconductor substrate. While a single photocell can see only one spot at a time, a CCD can see a cross-section of the whole rows or columns of fluorescence images at once. Single light-emitting diode (LED) illuminates a spot on the substrate and a photocell measures the amount of light reflected. As the LED and photocell move across the substrate, the pattern of fluorescence is captured and decoded. Instead of using a row of light-emitting diodes for illuminating the whole rows or columns of spots for the CCD, multiple in-parallel incoming light can be achieved by implementing waveguides and microlens arrays in the scanner system. For example, holographic array generator can be used to split the laser source into multiple in-parallel light beams.

In a wand scanner, light is focused through a small transparent ball at the tip.

Therefore, the present invention can attain high speed scanning with high resolution. For each spot on the substrate, an individual detection is performed without interference from other spots or the background. That is, each spot seems to have its own detection unit from utilizing the in-parallel incoming light and the in-parallel emitted fluorescence through the help of the microlens array and the optical switch. It is possible to detect signals produced by fluorescent features, no matter how dynamic or static they would be, on a specific site without compensating overall backgrounds. Therefore, the intensity of fluorescence emission on each individual spot can be counted, rather than overall scanning.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

1. A microarray system for light-directed synthesis, comprising:
a solid substrate having a plurality of locations thereon, wherein each location is immobilized with an introductory synthesizing unit, wherein the introductory synthesizing unit is composed of three linked nucleotides and protected by a protective group;
a light source for emitting light;
a synthesizing unit supply for feeding a synthesizing unit to each location, wherein the synthesizing unit is composed of three linked nucleotides;
a photoacid precursor supply for feeding photoacid with the synthesizing unit;
an optical switch for directing light onto each location individually, so as to de-protect the protecting group and activate synthesis in each location, wherein the synthesizing unit is linked to the introductory synthesizing unit.

2. The system of claim 1, wherein the optical switch includes at least an intersecting waveguide matrix for directing a direction of light, matching oil, microactuators and optical fibers for transmitting light.

3. The system of claim 2, wherein the intersecting waveguide matrix further comprises a plurality of intersecting waveguide cores, wherein a groove is disposed at each intersection connected to an oil pool, and wherein the groove and the oil pool contains matching oil.

4. The system of claim 2, wherein matching oil and the waveguide core have the same refractive indexes.

5. The system of claim 2, wherein the optical fibers are arranged aside the waveguide matrix as input optical fibers and output optical fibers for transmitting light.

6. The system of claim 2, wherein the microactuator is arranged above each intersection of the waveguide matrix and further comprises:
an electromagnet, a permanent magnet, a spring, and a cylinder, wherein the permanent magnet and the cylinder are mounted on the spring.

7. The system of claim 1, wherein a material for the solid substrate is selected from the following group consisting of glass, plastics, polyester (PET), polyimide (PI), polystyrene (PS) and silicon materials.

8. The system of claim 1, wherein the light source includes an ultraviolet light or a near ultraviolet light.

9. A method for light-directed synthesis, comprising:
(a) providing a solid substrate having a plurality of locations thereon;
(b) treating the solid substrate so as to functionalize a surface of the substrate and immobilize a first synthesizing unit in each location on the surface of the substrate, wherein the first synthesizing unit is composed of three linked nucleotides and protected by a protecting group;
(c) providing a light source for emitting light;
(d) feeding a second synthesizing unit to each location, wherein the second synthesizing unit is composed of three linked nucleotides; and
(e) providing an optical switch for directing light onto each location individually, so as to de-protect the protecting group and activate synthesis in each location, wherein the second synthesizing unit is linked to the first synthesizing unit.

10. The method of claim 9, wherein the step of feeding the second synthesizing unit further including feeding a photoacid.

11. The method of claim 9, wherein the steps of (d) and (e) are repeated.

12. The method of claim 9, wherein a material for the solid substrate is selected from the following group consisting of glass, plastics, polyester (PET), polyimide (PI), polystyrene (PS) and silicon materials.

13. The method of claim 9, wherein the optical switch includes at least an intersecting waveguide matrix, matching oil, microactuators and optical fibers.

14. The method of claim 9, wherein the light source includes an ultraviolet light or a near ultraviolet light.

15. A detection system, applied for detecting a microarray system, comprising:
a light source for emitting multiple in-parallel light;
a first microlens array having a plurality of first lenses disposed above the microarray system;
a detector;
a first optical waveguide switch disposed between the light source and the microlens array, wherein the optical waveguide switch is moved by a first robotic arm, so that emitted light from the light source is directed through the first optical waveguide switch and focused by the first lenses on the first microlens array onto the microarray system to excite fluorescence;
a splitter for transmitting light from the light source to the microarray system and reflect emitted fluorescence to a second optical waveguide switch;
a second microlens array having a plurality of second lenses disposed above the detector, wherein emitted fluorescence from the microarray system is focused by the second lenses on the second microlens array to the second optical waveguide switch; and
the second optical waveguide switch disposed between the splitter and the detector, wherein the second optical waveguide switch is removed by a second robotic arm, so that focused fluorescence from the second microlens array is directed through the second optical waveguide switch to the detector.

16. The system of claim 15, wherein the system further comprises reflector mirrors for reflecting fluorescence and an emission filter for filtering out background noises between the microarray system and the second microlens arrays.

17. The system of claim 15, wherein the detector is a charge coupled device (CCD) unit having a plurality of photocells.

18. The system of claim 15, wherein the light source includes a laser light source split by holographic array generator.
